(19) United States
(12) Patent Application Publication
(10) Pub. No.: US 2024/0037701 A1
(43) Pub. Date: Feb. 1, 2024

(54) IMAGE PROCESSING AND RENDERING

(71) Applicant: Tencent Technology (Shenzhen) Company Limited, Shenzhen (CN)

(72) Inventors: Koon Wing Macgyver Lin, Shenzhen (CN); Wenbo Xi, Shenzhen (CN)

(73) Assignee: Tencent Technology (Shenzhen) Company Limited, Shenzhen (CN)

(21) Appl. No.: 18/379,332

(22) Filed: Oct. 12, 2023

Related U.S. Application Data
(63) Continuation of application No. PCT/CN2023/074883, filed on Feb. 8, 2023.

(30) Foreign Application Priority Data
Mar. 10, 2022 (CN) 202210230954.6

(51) Int. Cl. G06T 3/40; G06T 7/90; G06T 7/73; G06T 7/11; A63F 13/25

(52) U.S. Cl. CPC G06T 3/4007; G06T 7/90; G06T 7/73; G06T 7/11; A63F 13/25; G06T 2207/10024; G06T 2207/20021

(57) ABSTRACT

Various image processing features are described. An interpolated pixel block of a first image may be used to generate a second image. Several types of interpolation may be available for obtaining the interpolated pixel block, and a particular type of interpolation may be determined based on various conditions, such as whether an interpolation feature of a first pixel block in the first image satisfies a feature determination condition. Different interpolation may be performed on the first pixel block according to complexity of image content in the first pixel block, which effectively reduces the computational complexity of up-sampling, avoids the computational resource waste caused by high computational resource consumption interpolation in the case of simple image content, and further reduces computational complexity.

### CROSS-REFERENCE TO RELATED APPLICATIONS

This application claims priority to PCT/CN2023/074883, filed Feb. 8, 2023, which in turn claims priority to Chinese Patent Application No. 202210230954.6, entitled “IMAGE PROCESSING METHOD, GAME RENDERING METHOD, APPARATUSES, DEVICE, AND STORAGE MEDIUM”, filed on Mar. 10, 2022, with the China National Intellectual Property Administration. The contents of these applications are incorporated by reference herein in their entirety.

### FIELD OF THE TECHNOLOGY

This application relates to the technical field of computers, and in particular, to an image processing method, a game rendering method, apparatuses, a device, a program product, and a storage medium.

### BACKGROUND OF THE DISCLOSURE

With the development of computer technology, in order to pursue a better image display effect, high requirements are put forward for image resolution.

In the related art, the image resolution of a low-resolution image is generally increased by up-sampling; the low-resolution image is enlarged to a high resolution using a spatial enlargement algorithm, and the enlargement process does not depend on other additional data, so that a better display effect is obtained for the low-resolution image.

However, the up-sampling process requires a large number of calculations. In practical applications, high demands are placed on the computing power of computer devices. How to reduce the computational complexity is an urgent problem to be solved.

### SUMMARY

This application provides an image processing method, a game rendering method, apparatuses, a device, a program product, and a storage medium, and the technical solutions are as follows:

Described herein is an image processing method, which may include the following steps:
acquiring a first image having a first resolution;
calculating an interpolation feature of a first pixel block in the first image according to the first image, the interpolation feature being used for describing image content of the first pixel block;
performing, if the interpolation feature of the first pixel block does not satisfy a feature determination condition, first interpolation on the first pixel block to obtain an interpolated pixel block, the feature determination condition being a determination condition regarding complexity of the image content of the first pixel block; performing, if the interpolation feature of the first pixel block satisfies the feature determination condition, second interpolation on the first pixel block to obtain the interpolated pixel block; and
outputting a second image with a second resolution based on the interpolated pixel block, the second resolution being greater than the first resolution,
wherein the first interpolation and the second interpolation are used for up-sampling the first pixel block, and computational resource consumption of the second interpolation being greater than computational resource consumption of the first interpolation.

Described herein is a game rendering method executed by a game device, which may comprise the following steps:
determining a first resolution and a second resolution, the first resolution being an output resolution of a game engine, and the second resolution being a display resolution of the game device;
acquiring a first image, output by the game engine, based on the first resolution; and
using, based on the first image, an image processing method to obtain a second image with the second resolution for display,
wherein the image processing method comprises the above image processing method.

Described herein is an image processing apparatus, which may comprise:
an acquisition module, configured to acquire a first image with a first resolution;
a calculation module, configured to calculate an interpolation feature of a first pixel block in the first image according to the first image, the interpolation feature being used for describing image content of the first pixel block;
a processing module, configured to perform, if the interpolation feature of the first pixel block does not satisfy a feature determination condition, first interpolation on the first pixel block to obtain an interpolated pixel block, the feature determination condition being a determination condition regarding complexity of the image content of the first pixel block;
wherein the processing module is further configured to perform, if the interpolation feature of the first pixel block satisfies the feature determination condition, second interpolation on the first pixel block to obtain the interpolated pixel block; and
an output module, configured to output a second image with a second resolution based on the interpolated pixel block, the second resolution being greater than the first resolution,
wherein the first interpolation and the second interpolation are used for up-sampling the first pixel block, and computational resource consumption of the second interpolation is greater than computational resource consumption of the first interpolation.

Described herein is a game rendering apparatus, which may be a game device comprising:
a determination module, configured to determine a first resolution and a second resolution, the first resolution being an output resolution of a game engine, and the second resolution being a display resolution of the game device;
an acquisition module, configured to acquire a first image output by the game engine based on the first resolution; and
a processing module, configured to use, based on the first image, an image processing apparatus to obtain a second image with the second resolution for display,
wherein the image processing apparatus comprises the above image processing apparatus.

Described herein is a computer device, which may comprise: a processor and a memory, the memory storing at least one program, and the processor being configured to execute the at least one program in the memory to implement the above image processing method or game rendering method.

Described herein is a computer-readable storage medium storing therein executable instructions, the executable instructions being loaded and executed by a processor to implement the above image processing method or game rendering method.

Described herein is a computer program product, which may comprise computer instructions stored in a computer-readable storage medium, and a processor reading and executing the computer instructions from the computer-readable storage medium to implement the above image processing method or game rendering method.

### BRIEF DESCRIPTION OF THE DRAWINGS

In order to explain the technical solutions of the embodiments of this application more clearly, the following description is given with reference to the drawings, which are required to be used in the description of the embodiments. The drawings in the following description are only some embodiments of this application, and various variations may be made.

FIG. 1 is a block diagram of a computer system provided by an example embodiment of this application.

FIG. 2 is a flowchart of an image processing method provided by an example embodiment of this application.

FIG. 3 is a flowchart of an image processing method provided by an example embodiment of this application.

FIG. 4 is a diagram of a first image provided by an example embodiment of this application.

FIG. 5 is a flowchart of an image processing method provided by an example embodiment of this application.

FIG. 6 is a flowchart of an image processing method provided by an example embodiment of this application.

FIG. 7 is a diagram of a first image provided by an example embodiment of this application.

FIG. 8 is a diagram of a first image provided by an example embodiment of this application.

FIG. 9 is a flowchart of performing a first interpolation provided by an example embodiment of this application.

FIG. 10 is a flowchart of performing a second interpolation provided by an example embodiment of this application.

FIG. 11 is a flowchart of an image processing method provided by an example embodiment of this application.

FIG. 12 is a flowchart of an image processing method provided by an example embodiment of this application.

FIG. 13 is a flowchart of an image processing method provided by an example embodiment of this application.

FIG. 14 is a diagram of a first image provided by an example embodiment of this application.

FIG. 15 is a diagram of a first image provided by an example embodiment of this application.

FIG. 16 is a diagram of a first image provided by an example embodiment of this application.

FIG. 17 is a diagram of a first image provided by an example embodiment of this application.

FIG. 18 is a flowchart of a game rendering method provided by an example embodiment of this application.

FIG. 19 is a diagram of displaying a first image provided by an example embodiment of this application.

FIG. 20 is a diagram of displaying a second image provided by an example embodiment of this application.

FIG. 21 is a structural block diagram of an image processing apparatus provided by an example embodiment of this application.

FIG. 22 is a structural block diagram of a game rendering apparatus provided by an example embodiment of this application.

FIG. 23 is a structural block diagram of a server provided by an example embodiment of this application.

The drawings, which are incorporated in and constitute a part of the present specification, illustrate embodiments consistent with this application and explain the principles of this application together with the specification.

### DESCRIPTION OF EMBODIMENTS

In order to make the objects, technical solutions, and advantages of this application clearer, implementations of this application will be further described in detail below with reference to the drawings.

Exemplary embodiments will be illustrated in detail herein, examples of which are shown in the drawings. Where the description below relates to the drawings, the same numbers in different drawings represent the same or similar elements unless otherwise indicated. The implementations described in the following exemplary embodiments do not represent all implementations consistent with this application. On the contrary, the implementations are merely examples of apparatuses and methods that are described in detail in the appended claims and that are consistent with some aspects of this application.

The terms used in the present disclosure are for the purpose of describing the specific embodiments only and are not intended to be limiting to the present disclosure. The terms “a”, “the” and “this” in the singular form as used in the present disclosure and the attached claims are also intended to include the majority form unless the context clearly indicates otherwise. It is to be further understood that the term “and/or” used herein indicates and contains any or all possible combinations of one or more associated listed items.

It should be noted that the user information (including but not limited to user equipment information, user personal information, and the like) and data (including but not limited to data used for analysis, stored data, displayed data, and the like) involved in this application are information and data authorized by the user or fully authorized by all parties. The collection, use, and processing of relevant data shall comply with relevant laws and regulations, and standards of relevant countries and regions. For example, the first image and the feature determination condition involved in this application are all acquired under the condition of sufficient authorization.

It is to be understood that, although the terms first, second, and the like may be used in the present disclosure to describe various information, such information is not to be limited to these terms. These terms are used only to distinguish the same type of information from one another. For example, a first parameter may also be referred to as a second parameter, and similarly, a second parameter may also be referred to as a first parameter, without departing from the scope of the present disclosure. Depending on the context, for example, the word “if” used herein may be interpreted as “while”, “when”, or “in response to determination.”

Firstly, several nouns involved in this application are briefly introduced:

Rendering channels: In creating computer-generated images, the final scenes that appear in movies and television works are typically generated by rendering a plurality of “layers” or “channels”, which are a plurality of images intended to be combined by digital synthesis to form a complete frame. Channel rendering is based on the tradition of motion-controlled photography before computer-generated imagery (CGI). For example, for visual effect shots, a camera may be programmed to pass once through a physical model of a spacecraft to capture a fully illuminated passage of the spacecraft, and then repeat the movement of the exact same camera through the spacecraft to again capture other elements, such as an illuminated window on the spacecraft or its propeller. After all channels have been captured, they can be optically printed together to form a complete image. In one expression, rendering layers and rendering channels may be used interchangeably. Layered rendering specifically refers to dividing different objects into separate images, for example, one layer each for foreground characters, scenery, long shot, and sky. Channel rendering, on the other hand, refers to separating different aspects of a scene (for example, shadows, highlights, or reflections) into separate images.

Resolution: The resolution of a digital television, computer display, or display device is the number of different pixels that can be displayed in each dimension. Resolution is controlled by various factors, which are usually referenced as width by height in pixels. For example, 1024 by 768 indicates a width of 1024 pixels and a height of 768 pixels. This example is commonly referred to as “ten-twenty-four by seven sixty eight” or “ten-twenty-four by seven six eight”. Those skilled in the art would understand that according to the number of pixels in length and width, the resolution of a display device corresponds to an aspect ratio. For example, common aspect ratios include but are not limited to 4:3, 16:9, and 8:5. For example, The full high definition (Full HD) has a resolution of 1920 by 1080 with an aspect ratio of 16:9. The ultra-extended graphics array (UXGA) has a resolution of 1600 by 1200 with an aspect ratio of 4:3. The wide quad extended graphics array (WQXGA) has a resolution of 2560 by 1600 with an aspect ratio of 8:5.

Implementations of this application are further described in detail below.

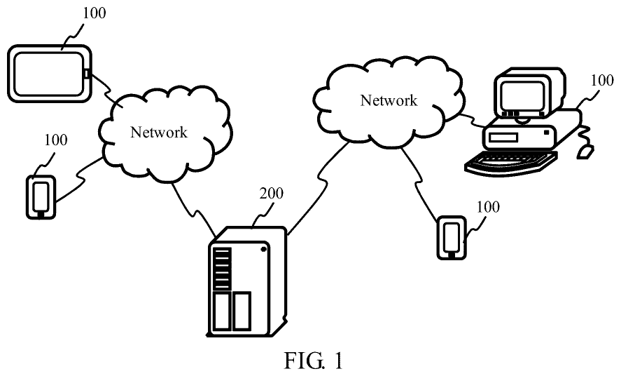

FIG. 1 shows a diagram of a computer system provided by an example embodiment of this application. The computer system may be implemented as a system architecture for an image processing method and/or a game rendering method. The computer system may include a terminal 100 and a server 200. The terminal 100 may be an electronic device such as a mobile phone, a tablet, a vehicle terminal (vehicle machine), a wearable device, or a personal computer (PC), and an unmanned scheduled terminal. A client running a target application (APP) may be installed in the terminal 100, and the target APP may be an image processing APP or other APPs provided with an image processing function, which is not limited to this application. In addition, this application does not limit the form of the target APP, including but not limited to an App, an applet, and the like installed in the terminal 100, and may also be in the form of a web page. The server 200 may be an independent physical server, a server cluster or a distributed system composed of a plurality of physical servers, or a cloud server that provides cloud computing services. The server 200 may be a background server of the above target APP for providing background services to clients of the target APP.

According to the image processing method and/or game rendering method provided herein, the execution subject of each step may be a computer device, which refers to an electronic device with data calculation, processing, and storage capabilities. Taking the scheme implementation environment shown in FIG. 1 as an example, the image processing method and/or game rendering method may be executed by a terminal 100 (for example, a client installed with a running target APP in the terminal 100 executes the image processing method and/or game rendering method), may also be executed by a server 200, or may be executed in interactive cooperation of the terminal 100 and the server 200, which is not limited in this application.

In addition, the technical solution of this application may be combined with blockchain technology. For example, in the image processing method and/or game rendering method disclosed in this application, some data involved (data such as a first image, a first pixel block, and a second pixel block) may be saved on a blockchain. The terminal 100 may communicate with the server 200 through a network, such as a wired or wireless network.

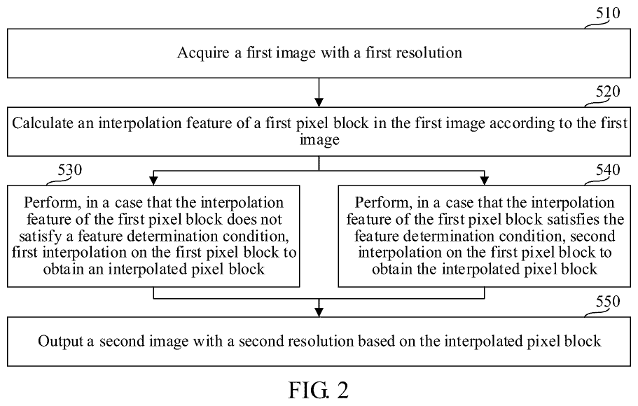

FIG. 2 shows a flowchart of an image processing method provided by an example embodiment of this application. The method may be executed by a computer device. The method includes the following steps:

Step 510: Acquire a first image having a first resolution.

In one embodiment, the first image includes at least two pixel blocks. Exemplarily, the first image includes a plurality of pixel points, and the at least two pixel blocks may include all the pixel points of the first image and may also include a part of all the pixel points of the first image.

Those skilled in the art will appreciate that one or more pixel points are included in a pixel block. There is usually no overlap between the at least two pixel blocks included in the first image, but it is not ruled out that there can be overlap.

Step 520: Calculate an interpolation feature of a first pixel block in the first image according to the first image.

For example, the first pixel block may be any pixel block of the at least two pixel blocks.

The interpolation feature may be used for describing the image content of the first pixel block, the first pixel block being any pixel block of the at least two pixel blocks. The dimension of the interpolation feature used for describing the image content of the first pixel block includes, but is not limited to, at least one of the following: color information about the first pixel block, luminance information about the first pixel block, gray information about the first pixel block, and position information about the first pixel block in the first image. It should be noted that for the interpolation feature, at least one of the above information about the first pixel block may be directly described; and at least one of the above information may be indirectly described through a change between the first pixel block and other pixel blocks or a convolution result between the first pixel block and other pixel blocks. The other pixel blocks are usually pixel blocks adjacent to the first pixel block, but the pixel blocks need not be adjacent to the first pixel block. At least one of the color information about the first pixel block, the luminance information about the first pixel block, the gray information about the first pixel block, and the position information about the first pixel block in the first image may be indirectly described by, but not limited to, at least one of a direction feature, a gradient feature, a Sobel operator.

Step 530: Perform, in a case that the interpolation feature of the first pixel block does not satisfy a feature determination condition, first interpolation on the first pixel block to obtain an interpolated pixel block.

The feature determination condition is for determining that the first pixel block is a pixel block whose image content is complex, that is, for describing the complexity of the image content of the first pixel block. In other words, the feature determination condition is a determination condition regarding the complexity of the image content. For example, the feature determination condition includes that the complexity of the image content of the first pixel block exceeds a target threshold.

The feature determination condition may determine the interpolation feature by setting a threshold. The feature determination condition may be preconfigured and adjustable, that is, for different first pixel blocks, different feature determination conditions may be set. If the interpolation feature of the first pixel block does not satisfy the feature determination condition, the first pixel block is a pixel block with a simple image content.

The first interpolation is used for up-sampling the first pixel block, and the up-sampling is used for improving the resolution of the first image.

Step 540: Perform, if the interpolation feature of the first pixel block satisfies the feature determination condition, second interpolation on the first pixel block to obtain the interpolated pixel block.

If the interpolation feature of the first pixel block satisfies the feature determination condition, the first pixel block may be a pixel block with a complex image content.

The first interpolation and the second interpolation are used for up-sampling the first pixel block; the computational resource consumption of the second interpolation is greater than that of the first interpolation, and the computational resource consumption is used for describing the computing complexity of the interpolation. The computing complexity of the interpolation is positively correlated with the computational resource consumption.

Step 550: Output a second image with a second resolution based on the interpolated pixel block.

Pixel blocks in the first image may be taken as first pixel blocks one by one, corresponding interpolated pixel blocks are calculated in sequence, and a second image is output according to the interpolated pixel blocks. The first interpolation and the second interpolation are used for up-sampling the first pixel block; and the second image output based on the interpolated pixel block has a second resolution which is greater than the first resolution which the first image has, that is, the second resolution is greater than the first resolution.

In summary, the method provided in the above example performs different interpolation on the first pixel block according to the complexity of the image content in the first pixel block by calculating the interpolation feature of the first pixel block. It effectively reduces the computational complexity of up-sampling, and avoids the computational resource waste caused by high computational resource consumption interpolation in the case of simple image content. On the premise of ensuring the effect of up-sampling, the computational resource consumption is reduced and the computational complexity is effectively reduced. In other words, the method may adopt, for different complexities of the image content of pixel blocks, a corresponding difference value method of the computing complexity, and can select an interpolation method according to the complexities of the image content, which helps to improve the flexibility of the device for image resolution adjustment and save the computational resources of the device under the premise of ensuring the effect of up-sampling.

Next, the process of calculating the interpolation features of the first image will be described through the following embodiments:

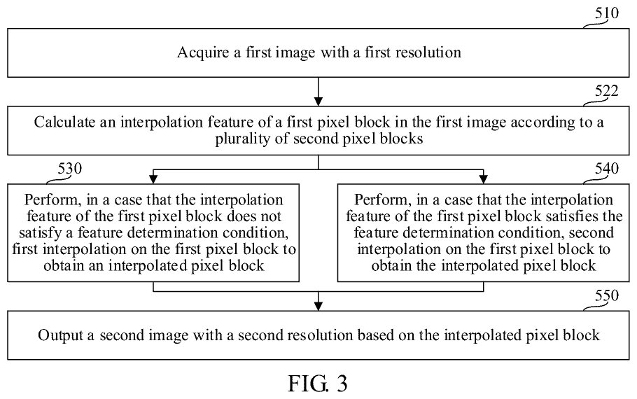

FIG. 3 shows a flowchart of an image processing method provided by an example embodiment of this application. The method may be executed by a computer device. Step 520 in FIG. 2 may be implemented as the following steps:

Step 522: Calculate the interpolation feature of the first pixel block in the first image according to a plurality of second pixel blocks.

Each second pixel block is a pixel block of the first image. Each second pixel block includes one or more pixel points. The number and/or arrangement of pixel points included in a first pixel block may be the same as the number and/or arrangement of pixel points included in a second pixel block. Further, a second pixel block includes a plurality of pixel blocks.

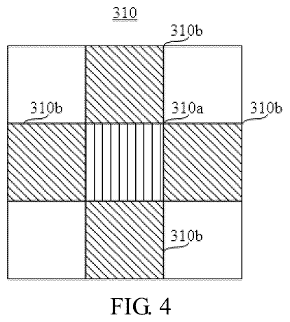

A plurality of second pixel blocks may be adjacent pixel blocks located around the first pixel block. The plurality of second pixel blocks may be arranged around the first pixel block. For example, FIG. 4 shows a diagram of a first image, the first image 310 including nine pixel blocks. The pixel blocks adjacent to the top, the bottom, the left, and the right of the first pixel block 310a are all the second pixel blocks 310b. In other words, the number of the second pixel blocks 310b is, for example, four, which are adjacent to the top, the bottom, the left, and the right of the first pixel block 310a. Those skilled in the art will appreciate that the above description is only an exemplary example, and that more or fewer pixel blocks adjacent to the first pixel block are second pixel blocks.

The interpolation feature of the first pixel block may be as follows:

dirX=G_{D}−G_{B};

dirY=G_{E}−G_{A};

dir=AH2(dirX,dirY);

dir2=dir*dir;

dirR=dir2.x+dir2.y;

G=0.299*Red+0.587*Green+0.114*Blue;

where dirR represents an interpolation feature; G represents gray information about a pixel block; and Red, Green, and Blue represent a red channel, a green channel, and a blue channel of a RGB color system; A represents a second pixel block adjacent to the top of the first pixel block; B represents a second pixel block adjacent to the left of the first pixel block; D represents a second pixel block adjacent to the right of the first pixel block; E represents a second pixel block adjacent to the bottom of the first pixel block; AH2 represents encapsulating as two-dimensional floating-point data; dir2.x represents a component of dir2 in an X direction, namely, a component in a left-right direction; dir2.y represents a component of dir2 in a Y direction, that is, a component in an up-down direction; intermediate variables also appear in the above formulate for convenient representation, such as dir.

Alternatively, step 522 may be implemented as the following sub-steps:

Sub-step 1: Calculate a direction feature of a first pixel block according to luminance factors of a plurality of second pixel blocks.

Sub-step 2: Determine a direction feature as an interpolation feature, the direction feature being used for describing a luminance difference between the first pixel block and the plurality of second pixel blocks.

Color information about the first image may include a luminance factor; and when using the RGB color system to describe the color information about the image color, the green channel may have the greatest influence on the luminance of the image. The green channel in the RGB color system is taken as the luminance factor.

Alternatively, sub-step 1 may have the following implementations:

Determining luminance differences between the first pixel block and the plurality of second pixel blocks in a first direction and a second direction according to difference values of luminance factors between different second pixel blocks,
for example:

dirX=I_{D}−I_{B};

dirY=I_{E}−I_{A};
where I represents a luminance factor of a pixel block; a difference value between the luminance factors of a pixel block D and a pixel block B is determined as a luminance difference between a first pixel block and a plurality of second pixel blocks in a first direction; a difference value between the luminance factors of a pixel block E and a pixel block A may be determined as a luminance difference between a first pixel block and a plurality of second pixel blocks in a second direction, the first direction and the second direction being perpendicular to each other; for the positional relationship between the plurality of second pixel blocks and the first pixel block, please refer to the previous description above;
encapsulating luminance differences between the first pixel block and the plurality of second pixel blocks into two-dimensional floating-point data to determine the luminance feature of the first pixel block,
for example:

dir=AH2(dirX,dirY);

dir2=dir*dir;
where dir2 represents the luminance feature of the first pixel block; AH2 represents encapsulating as encapsulating as two-dimensional floating-point data;
dir is an intermediate variable for convenient representation; and
determining a sum of a first direction component and a second direction component of the luminance feature in the first image as the direction feature of the first pixel block, for example:

dirR=dir2.x+dir2.y;
where dirR represents a direction feature of a first pixel block; dir2.x represents a first direction component of the luminance feature in the first image; and dir2.y represents a second direction component of the luminance feature in the first image.

The first direction and the second direction may be perpendicular to each other in the first image.

The determining luminance differences between the first pixel block and the plurality of second pixel blocks in a first direction and a second direction according to difference values of luminance factors between different second pixel blocks may include:
determining a first luminance difference of the first pixel block in the first direction according to a difference value of a luminance factor between a second pixel block at a front side of the first pixel block and a second pixel block at a rear side of the first pixel block in the first direction; and
determining a second luminance difference of the first pixel block in the second direction according to a difference value of a luminance factor between a second pixel block at a front side of the first pixel block and a second pixel block at a rear side of the first pixel block in the second direction in the second pixel blocks.

The encapsulating luminance differences between the first pixel block and the second pixel blocks into two-dimensional floating-point data to determine the luminance feature of the first pixel block may comprise encapsulating the first luminance difference and the second luminance difference into two-dimensional floating-point data to determine the luminance feature of the first pixel block.

In summary, the method provided in the above example calculates an interpolation feature of a first pixel block in a first image according to a second pixel block, expanding the dimension describing the image content of the first pixel block. The method performs different interpolation on the first pixel block according to complexity of image content in the first pixel block. It effectively reduces the computational complexity of up-sampling, and avoids the computational resource waste caused by high computational resource consumption interpolation in the case of simple image content. On the premise of ensuring the effect of up-sampling, the computational resource consumption is reduced and the computational complexity is effectively reduced. In other words, the method may adopt, for different complexities of the image content of pixel blocks, a corresponding difference value method of the computing complexity, and can select an interpolation method according to the complexities of the image content, which helps to improve the flexibility of the device for image resolution adjustment and save the computational resources of the device under the premise of ensuring the effect of up-sampling.

Next, the process of dividing pixel blocks in an image will be described by the following embodiments:

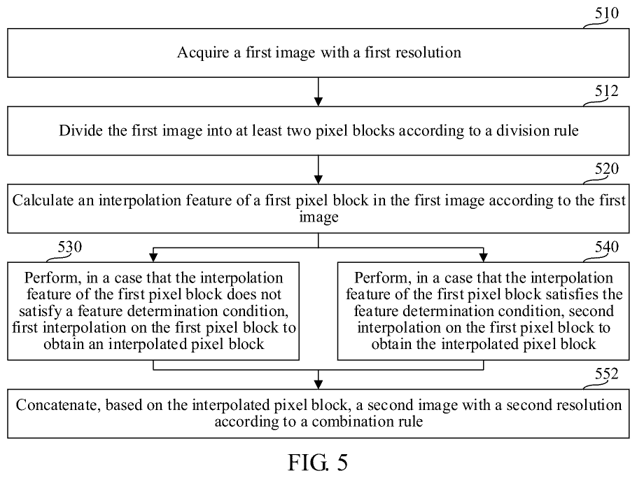

FIG. 5 shows a flowchart of an image processing method provided by an example embodiment of this application. The method may be executed by a computer device. That is, an alternative design, based on the embodiment shown in FIG. 2, may further include step 512, and step 550 may be implemented as step 552.

Step 512: Divide the first image into at least two pixel blocks according to a division rule.

In this example, the division rule does not make any limitation on at least one of the number of pixel points, the arrangement of the pixel points, and the image information about the pixel points included in the at least two pixel blocks.

The division rule may be used for describing a basis for dividing at least two pixel blocks in the first image. In one example, the division rule includes the position of the pixel block, and the division rule may directly or indirectly represent the position of the pixel block.

For example, the first image includes 16 by 16 pixel points; and the division rule indicates that the divided pixel blocks include 4 by 4 pixel points, the pixel blocks being closely arranged on the first image. Close arrangement may mean that there is no gap between pixel blocks and as many pixel blocks are divided as possible. The division rule indirectly indicates the position of the pixel block by indicating the pixel block size and compact arrangement.

For example, the first image includes 16 by 16 pixel points, and the division rule indicates to divide two pixel blocks; the position of pixel block 1 is from the first pixel point to the eighth pixel point from left to right in the first image, and from the first pixel point to the sixteenth pixel point from top to bottom. The division rule directly indicates the position of the pixel block.

Step 552: Concatenate, based on an interpolated pixel block, a second image with a second resolution according to a combination rule.

The interpolated pixel block may be determined based on a first pixel block, the first pixel block being part of the first image and the first pixel block being determined in the first image based on a division rule. According to the combination rule which is inverse to the division rule, the second image is obtained based on the interpolated pixel block concatenation, that is, the combination rule and the division rule are ordering rules which are inverse to each other.

In summary, the method provided in the above example lays the foundation for performing different interpolation on the first pixel block according to the complexity of the image content in the first pixel block by dividing the pixel block in the first image. It effectively reduces the computational complexity of up-sampling, and avoids the computational resource waste caused by high computational resource consumption interpolation in the case of simple image content. On the premise of ensuring the effect of up-sampling, the computational resource consumption is reduced and the computational complexity is effectively reduced.

Next, the first interpolation and the second interpolation will be described by the following embodiments:

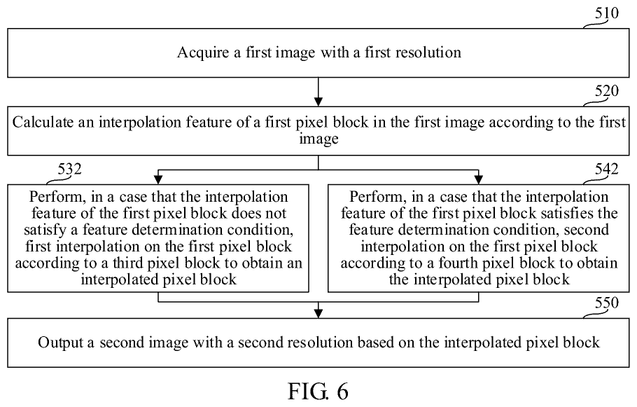

FIG. 6 shows a flowchart of an image processing method provided by an example embodiment of this application. The method may be executed by a computer device. That is, in an alternative design, based on the embodiment shown in FIG. 2, step 530 may be implemented as step 532, and step 540 may be implemented as step 542.

Step 532: Perform, if the interpolation feature of the first pixel block does not satisfy a feature determination condition, first interpolation on the first pixel block according to a third pixel block to obtain an interpolated pixel block.

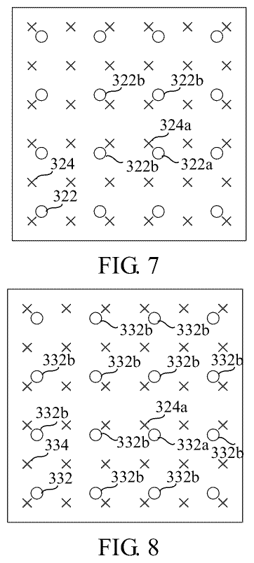

The third pixel block may be an adjacent pixel block of the first pixel block, and the third pixel block may be arranged around the first pixel block in a second arrangement. For example, FIG. 7 shows a diagram of a first image; the first image includes sixteen pixel blocks; an up-sampled second image includes thirty-six pixel blocks; and the second image is compressed and mapped on an image of the same size as the first image, a first marker 322, namely, sixteen circular markers shown in the drawings representing the central positions of the sixteen pixel blocks of the first image, and a second marker 324, namely, thirty-six cross markers representing the central positions of the thirty-six pixel blocks of the second image. The target second marker 324a is a central position of an interpolated pixel block. The first interpolation is performed on a first pixel block to obtain an interpolated pixel block; the central position of the first pixel block is indicated using a target first marker 322a. First interpolation is performed on the first pixel block according to a third pixel block; the third pixel block includes adjacent pixel blocks located around the first pixel block; and the central positions of a plurality of third pixel blocks are indicated using a target first marker 322a and an associated first marker 322b. It will be appreciated that the plurality of third pixel blocks include four pixel blocks of the same size as the first pixel block. In one embodiment, one third pixel block of the plurality of third pixel blocks is the first pixel block.

Those skilled in the art will appreciate that the above description is only an example, and that more or fewer pixel blocks adjacent to the first pixel block may be the third pixel blocks. The first arrangement may be the same or different.

Step 542: Perform, if the interpolation feature of the first pixel block satisfies the feature determination condition, second interpolation on the first pixel block according to a fourth pixel block to obtain the interpolated pixel block.

The fourth pixel block may comprise adjacent pixel blocks located around the first pixel block. The fourth pixel block is arranged around the first pixel block, for example, in a third arrangement. FIG. 8 shows a diagram of a first image; the first image includes sixteen pixel blocks; an up-sampled second image includes thirty-six pixel blocks; and the second image is compressed and mapped on an image of the same size as the first image, a first marker 332, namely, sixteen circular markers shown in the drawings representing the central positions of the sixteen pixel blocks of the first image, and a second marker 334, namely, thirty-six cross markers representing the central positions of the thirty-six pixel blocks of the second image. The target second marker 334a is a central position of an interpolated pixel block; the second interpolation is performed on the first pixel block to obtain the interpolated pixel block; and the central position of the first pixel block is indicated using the target first marker 332a. The second interpolation is performed on the first pixel block according to a fourth pixel block, the fourth pixel block being an adjacent pixel block of the first pixel block and a central position of the fourth pixel block being indicated using the target first marker 332a and an associated first marker 332b.

It can be understood by those skilled in the art that since the computational resource consumption of the second interpolation is greater than that of the first interpolation, the computational resource consumption may be used for describing the computing complexity of the interpolation. Alternatively, the number of pixel blocks in the fourth pixel blocks is greater than the number of pixel blocks in the third pixel blocks. That is, the computational complexity of performing the second interpolation based on a large number of fourth pixel blocks is greater than the computational complexity of performing the first interpolation based on a small number of third pixel blocks.

Those skilled in the art would understand that for the third pixel block and the fourth pixel block, there may be a case where the first pixel block is not included. For example, eight pixel blocks adjacent to the first pixel block are taken as the third pixel block or the fourth pixel block.

In summary, the method provided in the above example performs different interpolation on the first pixel block according to the complexity of the image content in the first pixel block by calculating the interpolation feature of the first pixel block. The first interpolation is performed on the first pixel block according to the third pixel block, and the second interpolation is performed on the first pixel block according to the fourth pixel block, providing different interpolation methods for the first pixel block. It effectively reduces the computational complexity of up-sampling, and avoids the computational resource waste caused by high computational resource consumption interpolation in the case of simple image content. On the premise of ensuring the effect of up-sampling, the computational resource consumption is reduced and the computational complexity is effectively reduced. In other words, by calculating the interpolation feature of the first pixel block and performing different interpolation on the first pixel block according to the complexity of the image content in the first pixel block, the embodiment of this application can adopt a corresponding difference value method of the computing complexity for different complexities of the image content of the pixel block, and can select an interpolation method according to the complexities of the image content, which helps to improve the flexibility of the device for image resolution adjustment and save the computational resources of the device under the premise of ensuring the effect of up-sampling.

Next, specific manners of the first interpolation and the second interpolation are described.

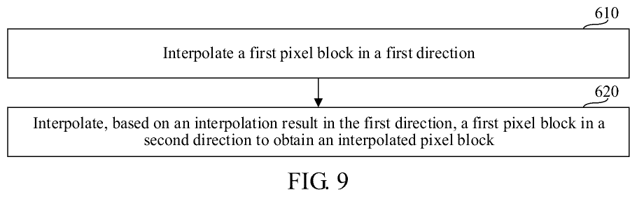

FIG. 9 shows a flowchart of performing a first interpolation provided by an example embodiment of this application, including the following steps:

Step 610: Interpolate a first pixel block in a first direction.

The first interpolation as a linear interpolation may be taken as an example for explanation. Those skilled in the art will appreciate that the first interpolation may be implemented as other interpolation methods, including but not limited to at least one of the following: nearest neighbor interpolation and bilinear interpolation.

The interpolation is performed on the first pixel block in the first direction; taking the diagram of the first image shown in FIG. 7 above as an example, the interpolation is performed on the first pixel block in the first direction to obtain an interpolation result in the first direction. The first direction is an x-axis direction of the first image. For example, the interpolation result in the first direction is:

$$f ( x , {y}_{1} ) = \frac{{x}_{2} - x}{{x}_{2} - {x}_{1}} f ( {Q}_{11} ) + \frac{x - {x}_{1}}{{x}_{2} - {x}_{1}} f ( {Q}_{21} ) ;$$

$$f ( x , {y}_{2} ) = \frac{{x}_{2} - x}{{x}_{2} - {x}_{1}} f ( {Q}_{12} ) + \frac{x - {x}_{1}}{{x}_{2} - {x}_{1}} f ( {Q}_{22} ) ;$$

where f(x,y₁) and f(x,y₂) represent interpolation results in a first direction; x represents an abscissa of a central position of an interpolated pixel block; x₁ represents an abscissa of a central position of a pixel block located on the left side of the third pixel block; x₂ represents an abscissa of a central position of a pixel block located on the right side of the third pixel block; f(Q₁₂) represents color information about a pixel block located on the upper left side of the third pixel block; f(Q₁₁) represents color information about a pixel block located on the lower left side of the third pixel block; f(Q₂₂) represents color information about a pixel block located on the upper right side of the third pixel block; and f(Q₂₁) represents color information about a pixel block located on the lower right side of the third pixel block.

Step 620: Interpolate, based on an interpolation result in the first direction, a first pixel block in a second direction to obtain an interpolated pixel block.

The interpolation is performed on the first pixel block in the second direction; taking the diagram of the first image shown in FIG. 7 above as an example, the interpolation is performed on the first pixel block in the second direction to obtain an interpolation result in the second direction, the interpolation result in the second direction being an interpolated pixel block. The first direction is a y-axis direction of the first image. For example, the interpolation result in the second direction is:

$$f ( x , y ) = \frac{{y}_{2} - y}{{y}_{2} - {y}_{1}} f ( x , {y}_{1} ) = \frac{y - {y}_{1}}{{y}_{2} - {y}_{1}} f ( x , {y}_{2} ) ;$$

$$f ( x , y ) = \frac{{y}_{2} - y}{{y}_{2} - {y}_{1}} ( \frac{{x}_{2} - x}{{x}_{2} - {x}_{1}} f ( {Q}_{11} ) + \frac{x - {x}_{1}}{{x}_{2} - {x}_{1}} f ( {Q}_{21} ) ) + \frac{y - {y}_{1}}{{y}_{2} - {y}_{1}} ( \frac{{x}_{2} - x}{{x}_{2} - {x}_{1}} f ( {Q}_{12} ) + \frac{x - {x}_{1}}{{x}_{2} - {x}_{1}} f ( {Q}_{22} ) ) ;$$

$$f ( x , y ) = \frac{1}{( {x}_{2} - {x}_{1} ) ( {y}_{2} - {y}_{1} )} [ \begin{matrix}{x}_{2} - x & x - {x}_{1} ]\end{matrix} [ \begin{matrix}f ( {Q}_{11} ) & f ( {Q}_{12} ) \\ f ( {Q}_{21} ) & f ( {Q}_{22} )\end{matrix} ] [ \begin{matrix}{y}_{2} - y \\ y - {y}_{1}\end{matrix} ] ;$$

where f(x,y₁) and f(x,y₂) represent an interpolation result in a first direction; f(x,y) represents an interpolation result in a second direction, namely, color information about an interpolated pixel block; y represents an ordinate of the central position of the interpolated pixel block; y₁ represents an ordinate of a central position of a pixel block located on the lower side of the third pixel block; y₂ represents an ordinate of a central position of a pixel block located on the upper side of the third pixel block. The above second formula is obtained by expanding the interpolation result in the first direction in the first formula; the meanings of each parameter in the expansion formula of the interpolation result in the first direction are as described above in step 610. It will be appreciated by the skilled in the art that the above third formula is a simplification of the second formula.

In summary, the method provided in the above example provides an interpolation method with a small computational resource consumption when the first pixel block is a simple pixel block by implementing the first interpolation as a linear interpolation, which effectively reduces the computational complexity of up-sampling, and avoids the computational resource waste caused by high computational resource consumption interpolation in the case of simple image content. On the premise of ensuring the effect of up-sampling, the computational resource consumption is reduced and the computational complexity is effectively reduced.

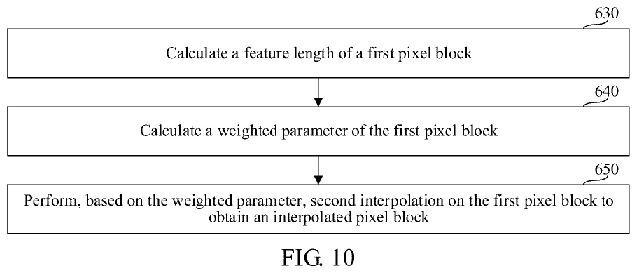

FIG. 10 shows a flowchart of performing a second interpolation provided by an example embodiment of this application, including the following steps:

Step 630: Calculate a feature length of the first pixel block.

The second interpolation as a Lanczos interpolation may be taken as an example. Those skilled in the art will appreciate that the second interpolation may be implemented as other interpolation methods, including but not limited to cubic interpolation.

For example, the feature length of the first pixel block may be calculated as follows:

$$dirX = {I}_{D} - {I}_{B} ;$$

$$dirY = {I}_{E} - {I}_{A} ;$$

$$dir = AH 2 ( dirX , dirY ) ;$$

$$dir2 = dir * dir ;$$

$$dirR = dir 2. x + dir 2. y ;$$

$$dc = {I}_{D} - {I}_{C} ;$$

$$cb = {I}_{C} - {I}_{B} ;$$

$$lenX = \frac{1.}{max ( abs ( dc ) , abs ( cb ) )} ;$$

$$lenX = saturate ( abs ( dirX ) * lenX ) ;$$

$$lenX = lenX * lenX ;$$

$$ec = {I}_{E} - {I}_{C} ;$$

$$ca = {I}_{C} - {I}_{A} ;$$

$$lenY = \frac{1.}{max ( abs ( ec ) , abs ( ca ) )} ;$$

$$lenY = saturate ( abs ( dirY ) * lenY ) ;$$

$$lenY = lenY * lenY ;$$

where I represents a luminance factor of a pixel block, and as an example, the luminance factor is represented by a green channel of a RGB color system; A represents a pixel block adjacent to the top of the first pixel block; B represents a pixel block adjacent to the left of the first pixel block; D represents a pixel block adjacent to the right of the first pixel block; E represents a pixel block adjacent to the bottom of the first pixel block; AH2 represents encapsulating as two-dimensional floating-point data; dir2.x represents a component of dir2 in an X direction, namely, a component in a left-right direction; dir2.y represents a component of dir2 in a Y direction, that is, a component in an up-down direction; saturate represents saturation function calculation; max represents maximum value calculation; abs represents absolute value calculation; and intermediate variables also appear in the above formulate for convenient representation, such as dir.

It should be noted that the above eighth formula to the tenth formula is successively executed according to an existing order; and the equal sign “=” in the ninth formula and the tenth formula is an assignment symbol, namely, updating lenX of the left side of the equal sign through calculation on the right side of the assignment symbol; lenX represents the feature length in the X direction, namely, the feature length in the left-right direction. Similarly, the thirteenth formula to the fifteenth formula are successively executed according to the existing order; lenY is updated, lenY representing the feature length in the Y direction, namely, the feature length in the up-down direction.

Step 640: Calculate a weighted parameter of the first pixel block.

The weighted parameter of the first pixel block may provide a weight for a fourth pixel block adjacent to the first pixel block to be used in constructing the interpolated pixel block.

For example, the weighted parameters are:

$$len = lenX + lenY ;$$

$$dirR = \frac{1.}{sqrt ( dirR )} ;$$

$$dir = dir * AH 2 ( dirR ) ;$$

$$len = len * AH 1 ( 0 \text{.5} ) ;$$

$$len = len * len ;$$

$$stretch = ( dir . x * dir . x + dir . y \times dir . y ) * \frac{1.}{max ( abs ( dir . x ) , abs ( dir . y ) )} ;$$

$$len 2 = AH 2 ( AH1 ( 1. ) + ( stretch - AH 1 ( 1. ) ) * len ,$$

$$AH 1 ( 1. ) + AH 1 ( - 0.5 ) * len ) ;$$

$$lob = A H 1 ( 0.5 ) + AH1 ( ( 1. / 4.0 - 0.04 ) - 0 \text{.5} ) * len ;$$

$$clp = 1. / lob ;$$

where sqrt represents square root calculation; max represents maximum value calculation; abs represents absolute value calculation; AH1 represents encapsulating as one-dimensional data; AH2 represents encapsulating as two-dimensional floating-point data; dir.x represents a component of dir in the X direction, that is, a component in the left-right direction; dir.y represents a component of dir in a Y direction, that is, a component in an up-down direction; the weighted parameters include len2 and clp, clp representing a clipping point, and lob representing a negative leaf intensity; intermediate variables also appear in the above formulate for convenient representation, such as stretch.

It should be noted that the above second formula to the fifth formula are successively executed according to an existing order; an equal sign “=” in the formula is an assignment symbol, that is, dirR, dir, and len of the left side of the equal sign is updated through calculation on the right side of the assignment symbol.

Step 650: Perform, based on a weighted parameter, second interpolation on a first pixel block to obtain an interpolated pixel block.

Based on the fourth pixel block, the second interpolation may be performed on the first pixel block according to the weighted parameter determined in step 640 to obtain an interpolated pixel block. For example, the fourth pixel block in the embodiment is the same as the fourth pixel block shown in FIG. 8, that is, includes twelve pixel blocks.

For example, the weights of the fourth pixel block are:

$$L ( x ) = [ \frac{25}{16} {( \frac{2}{5} {x}^{2} - 1 )}^{2} - ( \frac{25}{16} - 1 ) ] {( w {x}^{2} - 1 )}^{2} ;$$

where x represents the weighted parameter len2 in step 640; w represents the weighted parameter clp in step 640; L(x) represents the weight of the fourth pixel block, that is, a weight coefficient including twelve pixel blocks.

The color information about the interpolated pixel block is a weighted average of the color information about the first pixel block, that is, the average obtained by multiplying the color information about the fourth pixel block by the weight coefficient is determined as the color information about the interpolated pixel block.

In summary, the method provided in the above example provides an interpolation method with a large computational resource consumption if the first pixel block is a complex pixel block by implementing the second interpolation as Lansos interpolation, thereby effectively ensuring the up-sampling effect on the complex pixel block. At the same time, it avoids the computational resource waste caused by high computational resource consumption interpolation in the case of simple image content, and effectively reduces the computational complexity.

Next, the feature determination condition will be described by the following embodiments:

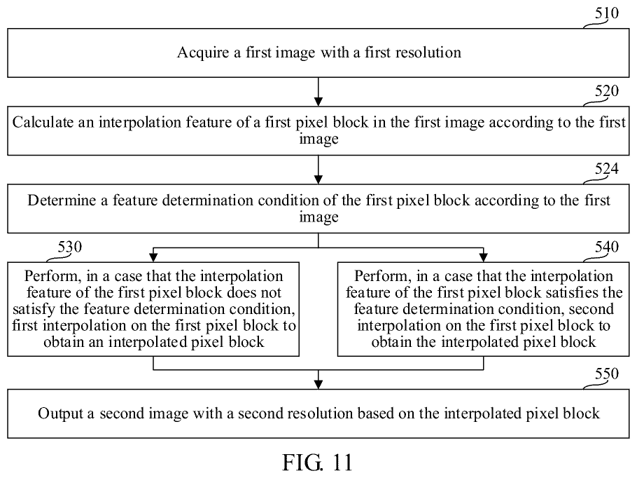

FIG. 11 shows a flowchart of an image processing method provided by an example embodiment of this application. The method may be executed by a computer device. Namely, in an alternative design, based on the embodiment shown in FIG. 2, the following steps are also included:

Step 524: Determine a feature determination condition of the first pixel block according to the first image.

For different first pixel blocks, different feature determination conditions may be set. For example, the feature determination condition is determined based on the first image. Since the computational complexity of the second interpolation is greater than that of the first interpolation, that is, the up-sampling effect of the second interpolation is better than that of the first interpolation, the first image is divided into a key region and a non-key region, and a feature determination condition is determined according to the first image. For example, the display requirement of the key region in the first image is high; and a loose feature determination condition is set in the key region to increase the number of first pixel blocks for performing the second interpolation. The display requirement of the non-key region in the first image is low; and a strict feature determination condition is set in the non-key region to reduce the number of first pixel blocks for performing the second interpolation.

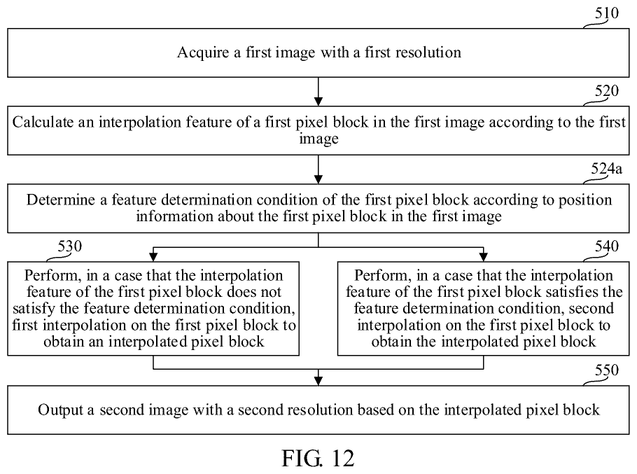

Alternatively, as shown in FIG. 12, step 524 may be implemented as step 524a:

Step 524a: Determine a feature determination condition of the first pixel block according to position information about the first pixel block in the first image.

A target region may be determined in the first image; and a feature determination condition of the first pixel block may be determined according to whether the position of the first pixel block is in the target region. It should be noted that the target region is predetermined, and no limitation is made on at least one of the shape, size, and position of the target region. The target region may be a partial region of the first image.

Alternatively, step 524a may be implemented as follows:
determining that the feature determination condition of the first pixel block includes the complexity of the image content of the first pixel block exceeding a first target threshold in a case that the position of the first pixel block is within the target region; and
determining that the feature determination condition of the first pixel block includes the complexity of the image content of the first pixel block exceeding a second target threshold in a case that the position of the first pixel block is outside the target region,
wherein the first target threshold is less than the second target threshold, and the target region is a partial region of the first image.

In an example, a target region, with an area of 50% of the area of the first image and a same shape as the first image is determined in a central position of the first image. The feature determination condition determines the interpolation feature by setting a threshold.

A first threshold is set for the feature determination condition if the position of the first pixel block is in the target region. A second threshold is set for the feature determination condition in the case that the position of the first pixel block is located outside the target region, the first threshold being less than the second threshold. Namely, in the target region, the proportion of the pixel block performing the second interpolation is increased; the target region gets a better display effect.

It will be appreciated by those skilled in the art that the above method of determining a target region is only an exemplary description and that different target regions may be determined on different grounds.

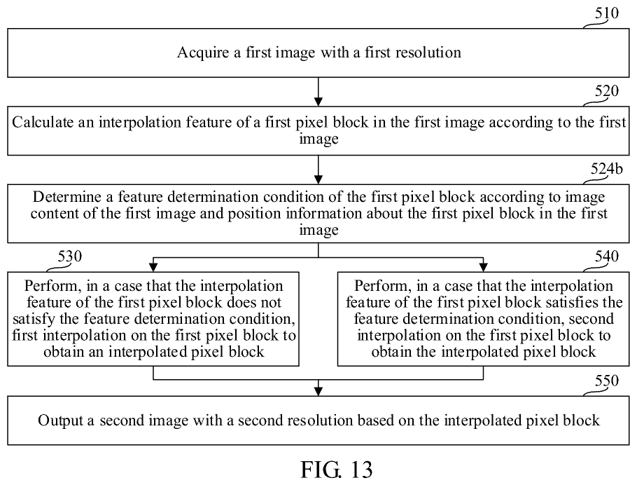

Alternatively, as shown in FIG. 13, step 524a may be implemented as step 524b:

Step 524b: Determine a feature determination condition of the first pixel block according to the image content of the first image and the position information about the first pixel block in the first image.

An image body region may be determined in the first image according to the image content of the first image; and a feature determination condition of the first pixel block may be determined according to whether the position of the first pixel block is in the image body region. It should be noted that there is no limitation on at least one of the shape, size, and position of the image body region. The image body region is a partial region of the first image.

Alternatively, step 524b may be implemented as follows:
determining an image body region in the first image according to the image content of the first image;
   determining that the feature determination condition of the first pixel block includes the complexity of the image content of the first pixel block exceeding a third target threshold if the position of the first pixel block is within the image body region; and
   determining that the feature determination condition of the first pixel block includes the complexity of the image content of the first pixel block exceeding a fourth target threshold if the position of the first pixel block is outside the image body region,
wherein the third target threshold is less than the fourth target threshold.

It should be noted that the image body region may be directly determined according to the image content of the first image, or may be indirectly determined according to the image content of the first image. An example description is as follows:

In one example, the image body region is determined directly from the image content of the first image.

A first image recognition model is invoked to identify a target object in the first image, and a display region of the target object is determined as an image body region in the first image.

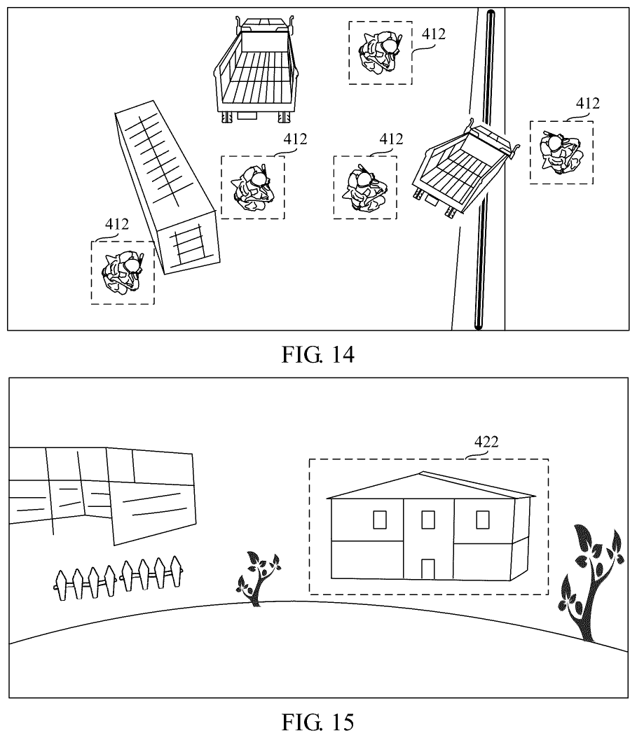

For example, when the target object identified in the first image is a virtual object, the first image recognition model takes a display region of the virtual object in the first image as an image body region. A loose feature determination condition is set in an image body region to increase the number of first pixel blocks for performing the second interpolation. FIG. 14 shows a diagram of a first image provided by an exemplary embodiment of this application. The display region 412 of the virtual object in the first image serves as an image body region, and if the position of the first pixel block is located within the image body region, the feature determination condition is loose. If the position of the first pixel block is located outside the image body region, for example, that the position of the first pixel block is in a display region of a virtual box, a virtual vehicle, or a virtual road, the feature determination condition is severe.

For example, when the target object identified in the first image is a virtual building, the first image recognition model takes a display region of the virtual building in the first image as an image body region. A loose feature determination condition is set in an image body region to increase the number of first pixel blocks for performing the second interpolation. FIG. 15 shows a diagram of a first image provided by an exemplary embodiment of this application. The display region 422 of the virtual building in the first image serves as an image body region, and if the position of the first pixel block is located within the image body region, the feature determination condition is loose. If the position of the first pixel block is located outside the image body region, for example, that the position of the first pixel block is in the display region of a virtual plant, a virtual fence, or a virtual mountain, the feature determination condition is severe.

In one example, the image body region is determined indirectly from the image content of the first image.

The second image recognition model is invoked to determine an image type of the first image in the first image, and a corresponding image body region is determined according to the image type.

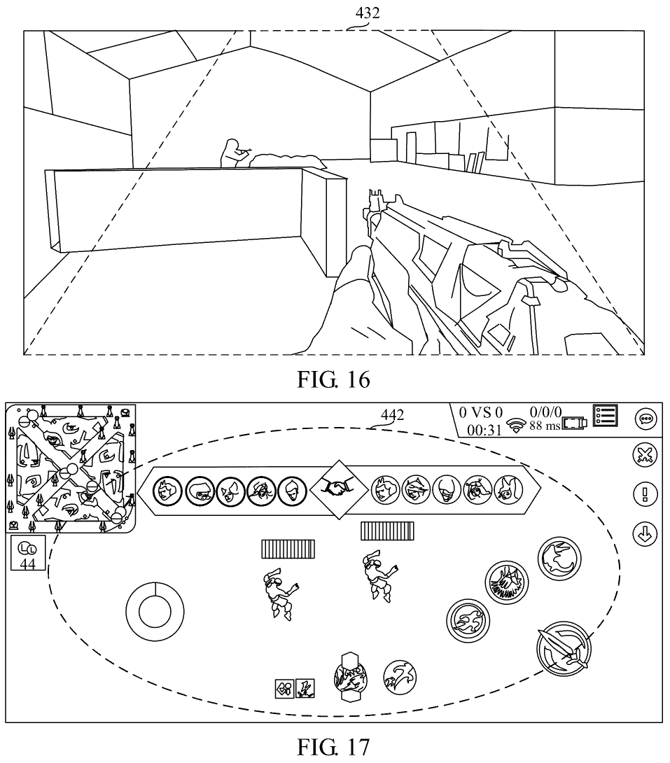

For example, for the first image being a game image of a first-person shooting game (FPS), the second image recognition model determines the image type of the first image as a first type in the first image, and takes a corresponding first region in the first image as an image body region. FIG. 16 shows a diagram of a first image provided by an example embodiment of this application. In the image of the first type, the trapezoidal region 432 is a region which needs to be focused on; for the image of the FPS game, there is a large amount of information and game content in the trapezoidal region 432; and if the position of the first pixel block is in the image body region, the feature determination condition is loose.

For example, for a first image being a game image of a multiplayer online battle arena game (MOBA), the second image recognition model determines an image type of the first image as a second type in the first image, and takes a corresponding second region in the first image as an image body region. FIG. 17 shows a diagram of a first image provided by an example embodiment of this application. In the image of the first type, the elliptical region 442 is a region that needs to be focused on; for the image of the MOBA game, there is a large amount of information and game content in the elliptical region 442; and if the position of the first pixel block is in the image body region, the feature determination condition is loose.

It should be noted that the first image recognition model and the second image recognition model are different models with different model structures and/or model parameters.

In summary, the method provided in the above example improves the evaluation capability of the feature determination condition on the first pixel block by determining the feature determination condition of the first pixel block, providing different interpolation bases for first pixel blocks at different positions. It effectively reduces the computational complexity of up-sampling, and further avoids the computational resource waste caused by high computational resource consumption interpolation in the case of simple image content. On the premise of ensuring the effect of up-sampling, the computational resource consumption is reduced and the computational complexity is effectively reduced.

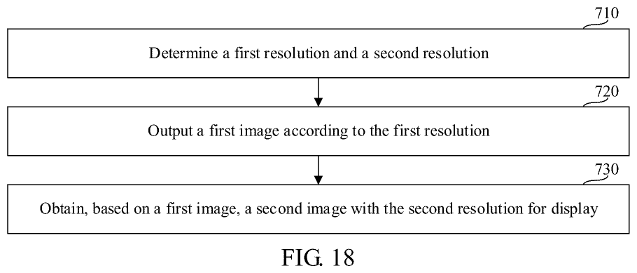

FIG. 18 shows a flowchart of a game rendering method provided by an example embodiment of this application. The method may be executed by a computer device, the computer device being a game device running a game engine. The method includes the following steps:

Step 710: Determine a first resolution and a second resolution.

The first resolution may be an output resolution of the game engine, and the second resolution may be a display resolution of the game device. The first resolution may be less than the second resolution.

The first resolution is an output resolution of the game engine, namely, the game engine renders the game picture according to the first resolution. Those skilled in the art would have been able to understand that the first resolution is small, and the computational complexity of the game picture rendering is small. That is, the size of the first resolution has a positive correlation with the computational complexity for rendering the game picture. It should be noted that the second resolution is the display resolution of the game device. The display resolution may be equal to the device resolution or may be less than the device resolution. Taking a game device as an example, for a smartphone with a resolution of 1920 by 1080, a plurality of display modes may be supported to display according to different resolutions. For example, the smartphone also supports display at any one of 1280 by 720 resolution and 640 by 360 resolution. In the case that the display is displayed with a resolution of 640 by 360, the display resolution is 640 by 360, that is, less than the device resolution.

It should be noted that the first resolution and the second resolution may be independent of each other or may be correlated, for example, the second resolution is determined, and the first resolution is determined based on the second resolution.

Step 720: Acquire a first image output by the game engine based on a first resolution.

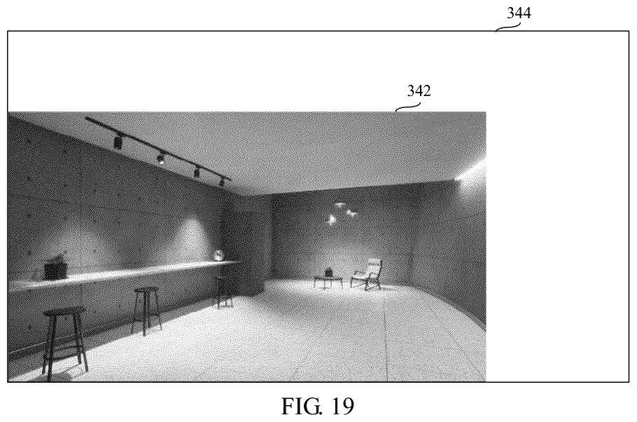

The first image may be a game picture image rendered by the game engine. FIG. 19 shows a diagram of displaying a first image provided by an example embodiment of this application. Since the first resolution is less than the second resolution, when the device displays the first image 342 at the first resolution, the device cannot fill the display device and there is a blank region 344.

Step 730: Use, based on the first image, an image processing method to obtain a second image with a second resolution for display.

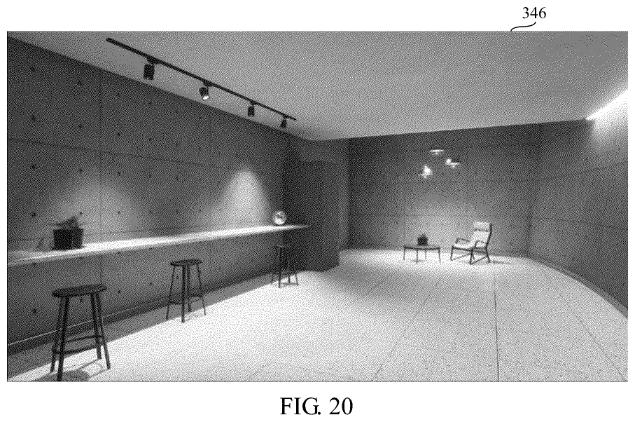

The image processing method is obtained according to an embodiment of any one of the above image processing methods. Since the second image has a second resolution, the second resolution is a device display resolution. FIG. 20 shows a diagram of displaying a second image provided by an example embodiment of this application. The device may fill the display device when displaying the second image 346 with the second resolution without a blank region.

In summary, the method provided in the above example performs different interpolation on a first pixel block by determining a first resolution and a second resolution in the game rendering scene and according to the complexity of the image content in the first pixel block. It effectively improves the quality of game-rendering images and avoids the low rendering effect caused by the computing power of the computer device. It reduces the computational resource consumption and computational complexity.

Next, the first resolution and the second resolution are described as follows:

If the first resolution and the second resolution are determined to be independent of each other, the first resolution may be determined as follows:

determining a first resolution based on the attribute information about the game device.

The attribute information about the game device may comprise at least one of the following: the computing power of the game device, the load condition of the game device, the temperature of the game device, and a model feature of the game device. For example, the game device generally includes a processor, for example, at least one of a central processing unit (CPU) and a graphics processing unit (GPU). Of course, other game devices with computing capabilities may also be included.

The computing power of the game device may be used for describing the number of calculations that a game device can bear per unit time; the stronger the computing power, the more times the computation may be performed at the same time.

The load condition of the game device may be used for describing a current operating state of a game device; for example, the first resolution is low in a case where the load condition of the game device is high.

The temperature of the game device may also be used; for example, in a case that the temperature of the game device is high, the game device is protected; the first resolution is low, and the amount of computation of the game device is reduced.

Model features of the game device are used for describing a specification of the game device; the first resolution is high in the case that a model feature of the game device indicates that the game device is a high-specification device.

Alternatively, the first resolution is determined as A1 by B1 in a case that the attribute information about the game device satisfies the target condition.

The first resolution is determined as A2 times B2 if the attribute information about the game device does not satisfy the target condition, A1 being greater than A2 and/or B1 being greater than B2, and A1, A2, B1, and B2 being positive integers.

In an example, the first resolution is represented by the number of horizontal pixel points times the number of longitudinal pixel points, such as 1920 by 1080.

The target condition includes at least one of the following:
The computing power of the game device is greater than the target capability threshold. For example, the target capability threshold is used for describing the number of calculations that a game device can bear per unit of time. For example, the target capability threshold is one hundred thousand operations per minute, and when the computing power of the game device is greater than one hundred thousand operations per minute, the attribute information about the game device satisfies the target condition.
A load condition of the game device is less than a target load threshold. For example, the target load threshold is used for describing an operational state of the game device, for example, the target load threshold is 75%, and when the load condition of the game device is less than 75% of full load, the attribute information about the game device satisfies the target condition.
The temperature of the game device is less than the target temperature threshold. For example, a target temperature threshold is used for describing the operating temperature of a game device, for example, the target temperature threshold is 85 degrees centigrade, and when the temperature of the game device is less than 85 degrees centigrade, the attribute information about the game device satisfies the target condition.
A model feature of the game device exceeds a target model feature. For example, the target model feature is used for describing a specification of a game device. For example, the target model feature is the first model product updated for the fourth time. When the model feature of the game device is the first model product for the sixth time, the target model feature is exceeded, and the attribute information about the game device satisfies the target condition.

In an example, where it is determined that there is an association between the first resolution and the second resolution, step 710 may be implemented as follows:

A second resolution is determined based on the display resolution of the game device; for example, the game device may fill the display device when displaying the second image with the second resolution without a blank region.

A product of a second resolution and a preset multiple is determined as a first resolution.

The first resolution is less than the second resolution; there is a multiple relationship between the first resolution and the second resolution, and the preset multiple is less than 1. It should be noted that the resolution is usually expressed as the number of horizontal pixel points timing the number of longitudinal pixel points, such as 1920 by 1080. However, it is not excluded that the resolution may be expressed by the total number of pixel points and the horizontal-longitudinal ratio, such as 2073600 and 16:9. Multiplying the second resolution by a preset multiple usually multiplies the number of horizontal pixel points and the number of longitudinal pixel points by a preset multiple to obtain the first resolution.

In summary, the method provided in the above example performs different interpolation on a first pixel block by determining a first resolution and a second resolution in the game rendering scene and according to the complexity of the image content in the first pixel block. The quality of the game rendering image is effectively improved. A first resolution is determined through the attribute information about a computer device, effectively ensuring that the computing power of the computer device is fully and rationally used. It lays the foundation for obtaining the second image with high resolution while avoiding the low rendering effect caused by the computing power of the computer device. It reduces the computational resource consumption and the computational complexity.

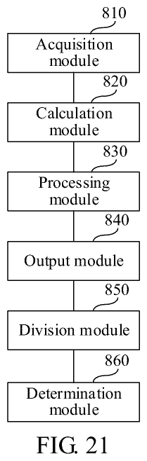

FIG. 21 shows a structural block diagram of an image processing apparatus provided by an example embodiment of this application. The apparatus includes:
an acquisition module 810, configured to acquire a first image with a first resolution;
a calculation module 820, configured to calculate an interpolation feature of a first pixel block in the first image according to the first image, the interpolation feature being used for describing image content of the first pixel block;
   a processing module 830, configured to perform, if the interpolation feature of the first pixel block does not satisfy a feature determination condition, first interpolation on the first pixel block to obtain an interpolated pixel block, the feature determination condition being a determination condition regarding complexity of the image content of the first pixel block;
   the processing module 830 may further be configured to perform, if the interpolation feature of the first pixel block satisfies the feature determination condition, second interpolation on the first pixel block to obtain the interpolated pixel block, the feature determination condition being a determination condition regarding complexity of the image content of the first pixel block; and
   an output module 840, configured to output a second image with a second resolution based on the interpolated pixel block, the second resolution being greater than the first resolution,
   wherein the first interpolation and the second interpolation are used for up-sampling the first pixel block, and computational resource consumption of the second interpolation is greater than computational resource consumption of the first interpolation.

Alternatively, the calculation module 820 is further configured to:
calculate the interpolation feature of the first pixel block in the first image according to a plurality of second pixel blocks, wherein the plurality of second pixel blocks comprises adjacent pixel blocks located around the first pixel block.

Alternatively, the color information about the first image may comprise a luminance factor. The first calculation module 820 is further configured to:
calculate a direction feature of the first pixel block according to luminance factors of the plurality of second pixel blocks; and
determine the direction feature as the interpolation feature, the direction feature being used for describing a luminance difference between the first pixel block and the plurality of second pixel blocks.

Alternatively, the calculation module 820 is further configured to:
determine luminance differences between the first pixel block and the second pixel blocks in a first direction and a second direction according to difference values of luminance factors between different second pixel blocks;
encapsulate luminance differences between the first pixel block and the plurality of second pixel blocks into two-dimensional floating-point data to determine the luminance feature of the first pixel block; and
determine a sum of a first direction component and a second direction component of the luminance feature in the first image as the direction feature of the first pixel block, wherein the first direction and the second direction being perpendicular to each other in the first image.

In an example, in order to determine the luminance differences between the first pixel block and the plurality of second pixel blocks in a first direction and a second direction, the calculation module 820 is configured to:
determine a first luminance difference of the first pixel block in the first direction according to a difference value of a luminance factor between a second pixel block at a front side of the first pixel block and a second pixel block at a rear side of the first pixel block in the first direction;
determine a second luminance difference of the first pixel block in the second direction according to a difference value of a luminance factor between a second pixel block at a front side of the first pixel block and a second pixel block at a rear side of the first pixel block in the second direction in the second pixel blocks; and
the encapsulating luminance differences between the first pixel block and the second pixel blocks into two-dimensional floating-point data to determine the luminance feature of the first pixel block includes encapsulating the first luminance difference and the second luminance difference into two-dimensional floating-point data to determine the luminance feature of the first pixel block.

Alternatively, the apparatus further includes:
a division module 850, configured to divide the first image into at least two pixel blocks according to a division rule, the first pixel block being any pixel block of the at least two pixel blocks; and
the output module 840, further configured to concatenate, based on the interpolated pixel block, into the second image with the second resolution according to a combination rule, the combination rule being an inverse ordering rule to the division rule.

Alternatively, the apparatus further includes:
a determination module 860, configured to determine the feature determination condition of the first pixel block according to the first image.

Alternatively, the determination module 860 is further configured to:
determine the feature determination condition of the first pixel block according to position information about the first pixel block in the first image.

Alternatively, the determination module 860 is further configured to:
determine that the feature determination condition of the first pixel block includes complexity of image content of the first pixel block exceeding a first target threshold if a position of the first pixel block is within a target region, the target region being a partial region of the first image; and
determine that the feature determination condition of the first pixel block includes the complexity of the image content of the first pixel block exceeding a second target threshold if the position of the first pixel block is outside the target region, the first target threshold being less than the second target threshold.

Alternatively, the determination module 860 is further configured to:
determine the feature determination condition of the first pixel block according to image content of the first image and the position information about the first pixel block in the first image.

Alternatively, the determination module 860 is further configured to:
determine an image body region in the first image according to the image content of the first image;
determine that the feature determination condition of the first pixel block includes complexity of image content of the first pixel block exceeding a third target threshold if a position of the first pixel block is within the image body region; and
determine that the feature determination condition of the first pixel block includes the complexity of the image content of the first pixel block exceeding a fourth target threshold if the position of the first pixel block is outside the image body region, the third target threshold being less than the fourth target threshold.

Alternatively, the determination module 860 is further configured to:
invoke a first image recognition model to identify a target object in the first image, and determine a display region of the target object as the image body region in the first image;
or, invoke a second image recognition model to determine an image type of the first image in the first image, and determine a corresponding image body region according to the image type.

Alternatively, the processing module 830 is further configured to:
perform, if the interpolation feature of the first pixel block does not satisfy the feature determination condition, the first interpolation on the first pixel block according to a third pixel block to obtain the interpolated pixel block, the third pixel block including adjacent pixel blocks located around the first pixel block; and
perform, if the interpolation feature of the first pixel block satisfies the feature determination condition, the second interpolation on the first pixel block according to a fourth pixel block to obtain the interpolated pixel block, the fourth pixel block including adjacent pixel blocks located around the first pixel block and the number of the fourth pixel block being greater than the number of the third pixel block.

Alternatively, the first interpolation includes linear interpolation, and the second interpolation includes Lansos interpolation.

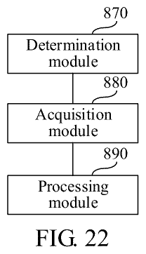

FIG. 22 shows a block diagram of a game rendering apparatus provided by an example embodiment of this application. The apparatus may be a game device, comprising:
a determination module 870, configured to determine a first resolution and a second resolution, the first resolution being an output resolution of a game engine, and the second resolution being a display resolution of the game device;
an acquisition module 880, configured to acquire a first image output by the game engine based on the first resolution; and
a processing module 890, configured to use, based on the first image, an image processing apparatus to obtain a second image with the second resolution for display, wherein the image processing apparatus is the image processing apparatus as described above.

Alternatively, the determination module 870 is further configured to:
determine the first resolution based on attribute information about the game device, the attribute information about the game device including at least one of the followings: a computing power of the game device, a load condition of the game device, a temperature of the game device, and a model feature of the game device.

Alternatively, the determination module 870 is further configured to determine the first resolution as A1 by B1 if the attribute information about the game device satisfies a target condition; and
determine the first resolution as A2 by B2 if the attribute information about the game device does not satisfy the target condition,
wherein A1 is greater than A2 and/or B1 being greater than B2, and the target condition including at least one of the following: the computing power of the game device being greater than a target power threshold, the load condition of the game device being less than a target load threshold, the temperature of the game device being less than a target temperature threshold, and the model feature of the game device exceeding a target model feature.

Alternatively, the determination module 870 is further configured to:
determine the second resolution according to a display resolution of the game device; and
determine the product of the second resolution and the preset multiple as the first resolution, the preset multiple being less than 1.

When the apparatus provided in the above embodiments implements the functions, the division of the above function modules is merely used as an example for description. In the practical application, the functions may be allocated to and completed by different function modules according to requirements. That is, an internal structure of the device is divided into different function modules, to complete all or some of the functions described above.

For the apparatus in the above embodiments, the specific manner where the various modules perform the operations has been described in detail in connection with the embodiments of the method. The technical effect achieved by the operations performed by the various modules is the same as the technical effect achieved in the embodiment relating to the method, and will not be described in detail herein.

The embodiment of this application further provides a computer device, including a processor and a memory, the memory storing computer programs, and the processor being configured to execute the computer programs in the memory to implement the image processing method or the game rendering method provided by the above method embodiments.

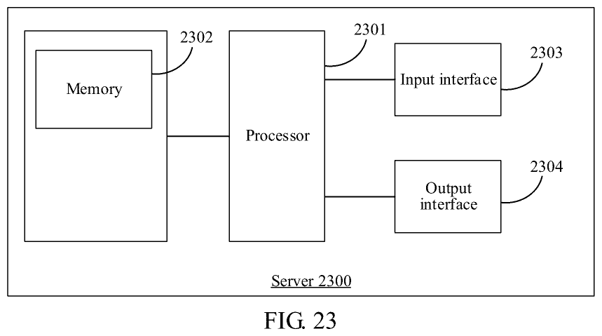

Alternatively, the computer device is a server. Exemplarily, FIG. 23 is a structural block diagram of a server provided by an exemplary embodiment of this application.

Generally, the server 2300 includes a processor 2301 and a memory 2302.

The processor 2301 may include one or more processing cores, for example, a 4-core processor or an 8-core processor. The processor 2301 may be implemented in at least one hardware form of a digital signal processing (DSP), a field-programmable gate array (FPGA), and a programmable logic array (PLA). The processor 2301 may further include a main processor and a co-processor, the main processor being a processor for processing data in a wake-up state, also referred to as a central processing unit (CPU), and a co-processor being a low-power processor for processing data in a standby state. In some embodiments, the processor 2301 may be integrated with a graphics processing unit (GPU), the GPU being configured to render and draw the content required by a display screen. In some embodiments, the processor 2301 may further include an artificial intelligence (AI) processor, the AI processor being configured to process computing operations related to machine learning.

The memory 2302 may include one or more computer-readable storage media. The computer-readable storage medium may be non-transient. The memory 2302 may further include a high-speed random-access memory and a nonvolatile memory, for example, one or more disk storage devices or flash storage devices. In some embodiments, the non-transitory computer-readable storage medium in the memory 2302 is configured to store at least one instruction, the at least one instruction being configured to be executed by the processor 2301 to implement the various features described herein, such as the image processing method or the game rendering method provided by the method embodiments of this application.

The server 2300 may further alternatively comprise an input interface 2303 and an output interface 2304. The processor 2301 and the memory 2302 may be connected to the input interface 2303 and the output interface 2304 through a bus or a signal cable. Each peripheral may be connected to the input interface 2303 and the output interface 2304 through a bus, a signal cable, or a circuit board. The input interface 2303 and output interface 2304 may be used for connecting at least one peripheral related to input/output (I/O) to the processor 2301 and the memory 2302. In some embodiments, the processor 2301, the memory 2302, the input interface 2303, and the output interface 2304 are integrated on the same chip or circuit board. In some other embodiments, any one or two of the processor 2301, the memory 2302, the input interface 2303, and the output interface 2304 may be implemented on a single chip or circuit board, which is not limited by the embodiments of this application.

Those skilled in the art will understand that the above structure constitutes no limitation on the server 2300, and may include more or fewer assemblies than those shown in the drawings, or combine some assemblies, or employ different assembly arrangements.

In an example embodiment, there is further provided a chip including programmable logic circuitry and/or program instructions for implementing the image processing method or game rendering method of the above aspects when the chip is run on a computer device.

In an example embodiment, there is further provided a computer program product including computer instructions stored in the computer-readable storage medium. The processor of the computer device reads the computer instructions from the computer-readable storage medium, and the processor reads and executes the computer instructions from the computer-readable storage medium to implement the image processing method or the game rendering method provided by the above method embodiments.

In an example embodiment, there is provided a computer-readable storage medium storing therein computer programs loaded and executed by a processor to implement the image processing method or the game rendering method provided by the above method embodiments.

Those of ordinary skill in the art will understand that all or some of the steps of the above embodiments may be implemented by hardware, or may be implemented by programs instructing relevant hardware. The programs may be stored in a computer-readable storage medium. The storage medium may be a read-only memory, a magnetic disk, an optical disc, or the like.

Those skilled in the art will appreciate that, in one or more of the above examples, the functions described in the embodiments of this application may be implemented in hardware, software, firmware, or any combination thereof. When implemented in software, the functions may be stored in a computer-readable medium or transmitted as one or more instructions or codes on the computer-readable medium. The computer-readable medium includes a computer storage medium and a communication medium, the communication medium including any medium that facilitates transfer of computer programs from one place to another. The storage medium may be any available medium that may be accessed by a general purpose or special purpose computer.

The above descriptions are merely alternative embodiments of this application, but are not intended to limit this application. Any modification, equivalent replacement, or improvement made within the spirit and principle of this application shall fall within the protection scope of this application.

What is claimed is:

1. An image processing method executed in a computer device, the method comprising:
acquiring a first image having a first resolution;
calculating an interpolation feature describing image content of a first pixel block in the first image;
obtaining an interpolated pixel block by:
performing a first interpolation on the first pixel block if the interpolation feature of the first pixel block does not satisfy a feature determination condition regarding complexity of the image content of the first pixel block; or
performing a second interpolation on the first pixel block if the interpolation feature satisfies the feature determination condition; and
outputting a second image with a second resolution based on the interpolated pixel block, the second resolution being greater than the first resolution,
wherein the first interpolation and the second interpolation comprise up-sampling of the first pixel block, and computational resource consumption of the second interpolation is greater than computational resource consumption of the first interpolation.

2. The method according to claim 1, wherein the calculating the interpolation feature comprises:
calculating the interpolation feature according to a plurality of second pixel blocks, the plurality of second pixel blocks comprising adjacent pixel blocks located around the first pixel block.

3. The method according to claim 2, wherein color information about the first image comprises a luminance factor; and the calculating the interpolation feature comprises:
calculating a direction feature of the first pixel block according to luminance factors of the plurality of second pixel blocks, wherein the direction feature describes a luminance difference between the first pixel block and the plurality of second pixel blocks; and
determining the direction feature as the interpolation feature.

4. The method according to claim 3, wherein the calculating a direction feature of the first pixel block according to luminance factors of the plurality of second pixel blocks comprises:
determining luminance differences between the first pixel block and the plurality of second pixel blocks in a first direction and a second direction; and
encapsulating the luminance differences into two-dimensional floating-point data to determine a luminance feature of the first pixel block; and
determining a sum of a first direction component and a second direction component of the luminance feature as the direction feature of the first pixel block,
wherein the first direction and the second direction are perpendicular to each other in the first image.

5. The method according to claim 4, wherein
the determining luminance differences comprises:
determining a first luminance difference of the first pixel block in the first direction according to a difference in luminance factor between:
a second pixel block at a front side of the first pixel block; and
a second pixel block at a rear side of the first pixel block in the first direction in the plurality of second pixel blocks;
determining a second luminance difference of the first pixel block in the second direction according to a difference in luminance factor between:
a second pixel block at a front side of the first pixel block; and
a second pixel block at a rear side of the first pixel block in the second direction in the plurality of second pixel blocks; and
the encapsulating the luminance differences comprises encapsulating the first luminance difference and the second luminance difference into the two-dimensional floating-point data to determine the luminance feature of the first pixel block.

6. The method according to claim 1, further comprising:
dividing the first image into at least two pixel blocks according to a division rule, the first pixel block being any pixel block of the at least two pixel blocks; and
wherein the outputting further comprises:
concatenating the interpolated pixel block and the second image according to a combination rule that comprises an inverse ordering rule to the division rule.

7. The method according to claim 1, further comprising:
determining the feature determination condition according to the first image.

8. The method according to claim 7, wherein the determining the feature determination condition comprises:
determining the feature determination condition according to position information about the first pixel block in the first image.

9. The method according to claim 8, wherein the determining the feature determination condition further comprises:
determining that the feature determination condition comprises complexity of image content of the first pixel block exceeding a first target threshold if a position of the first pixel block is within a target region that is a partial region of the first image; or
determining that the feature determination condition comprises the complexity of the image content of the first pixel block exceeding a second target threshold if the position of the first pixel block is outside the target region, wherein the first target threshold is less than the second target threshold.

10. The method according to claim 8, wherein the determining the feature determination condition further comprises:
determining the feature determination condition according to image content of the first image and the position information about the first pixel block in the first image.

11. The method according to claim 10, wherein the determining the feature determination condition further comprises:
determining an image body region in the first image according to the image content of the first image; and
determining that the feature determination condition comprises either:
complexity of image content of the first pixel block exceeding a third target threshold if a position of the first pixel block is within the image body region; or
complexity of the image content of the first pixel block exceeding a fourth target threshold if the position of the first pixel block is outside the image body region,
wherein the third target threshold is less than the fourth target threshold.

12. The method according to claim 11, wherein the determining an image body region in the first image according to the image content of the first image comprises:
invoking a first image recognition model to identify a target object in the first image, and determining a display region of the target object as the image body region in the first image;
or
invoking a second image recognition model to determine an image type of the first image in the first image, and determining a corresponding image body region according to the image type.

13. The method according to claim 1, wherein
the performing the first interpolation comprises:
performing the first interpolation on the first pixel block according to third pixel blocks to obtain the interpolated pixel block, wherein the third pixel blocks comprise adjacent pixel blocks located around the first pixel block; and
the performing the second interpolation comprises:
performing the second interpolation on the first pixel block according to fourth pixel blocks to obtain the interpolated pixel block, wherein the fourth pixel blocks comprise adjacent pixel blocks located around the first pixel block, and wherein a number of the fourth pixel blocks is greater than a number of the third pixel blocks.

14. The method of claim 1, wherein the computer device comprises a game device, wherein the first resolution comprises an output resolution of a game engine, and the second resolution comprises a display resolution of the game device, and
wherein acquiring the first image comprises acquiring the first image from the game engine.

15. The method according to claim 14, further comprising determining the first resolution based on attribute information about the game device,
wherein the attribute information about the game device comprises at least one of the following: a computing power of the game device, a load condition of the game device, a temperature of the game device, or a model feature of the game device.

16. The method according to claim 15, wherein the determining the first resolution comprises:
determining the first resolution as A1 by B1 if the attribute information about the game device satisfies a target condition; or
determining the first resolution as A2 by B2 if the attribute information about the game device does not satisfy the target condition,
wherein A1 is greater than A2 and/or B1 is greater than B2, and the target condition comprises at least one of the following: the computing power of the game device being greater than a target power threshold, the load condition of the game device being less than a target load threshold, the temperature of the game device being less than a target temperature threshold, or the model feature of the game device exceeding a target model feature.

17. An image processing apparatus, the apparatus comprising:
an acquisition module, configured to acquire a first image with a first resolution;
a calculation module, configured to calculate an interpolation feature of a first pixel block in the first image, wherein the interpolation feature describes image content of the first pixel block;
a processing module, configured to obtain an interpolated pixel block by performing:
first interpolation on the first pixel block if the interpolation feature does not satisfy a feature determination condition, wherein the feature determination condition comprises a determination condition regarding complexity of the image content of the first pixel block; or
second interpolation on the first pixel block if the interpolation satisfies the feature determination condition; and
an output module, configured to output a second image with a second resolution based on the interpolated pixel block, wherein the second resolution is greater than the first resolution,
wherein the first interpolation and the second interpolation comprise up-sampling the first pixel block, and computational resource consumption of the second interpolation is greater than computational resource consumption of the first interpolation.

18. One or more non-transitory computer-readable media storing instructions that, when executed, cause:
determining a first resolution and a second resolution, the first resolution being an output resolution of a game engine, and the second resolution being a display resolution of a game device;
acquiring a first image, output by the game engine, comprising the first resolution; and
obtaining an interpolated pixel block by:
performing a first interpolation on a first pixel block of the first image if an interpolation feature of the first pixel block does not satisfy a feature determination condition regarding complexity of image content of the first pixel block; or
performing a second interpolation on the first pixel block if the interpolation feature satisfies the feature determination condition; and:
generating a second image based on the interpolated pixel block.

19. The one or more non-transitory computer-readable media of claim 18, wherein the instructions, when executed, cause determining the interpolation feature by:
calculating the interpolation feature according to a plurality of second pixel blocks, the plurality of second pixel blocks comprising adjacent pixel blocks located around the first pixel block.

20. The one or more non-transitory computer-readable media of claim 19, wherein color information about the first image comprises a luminance factor; and the instructions, when executed, cause determining the interpolation feature by:
calculating a direction feature of the first pixel block according to luminance factors of the plurality of second pixel blocks, wherein the direction feature describes a luminance difference between the first pixel block and the plurality of second pixel blocks; and
determining the direction feature as the interpolation feature.
